(19) United States
(12) Patent Application Publication
(10) Pub. No.: US 2017/0048239 A1
(43) Pub. Date: Feb. 16, 2017

(54) SYSTEM AND METHOD FOR PROTECTING SECURITY OF BIOMETRIC INFORMATION OF DRIVER

(71) Applicant: HYUNDAI MOTOR COMPANY, Seoul (KR)

(72) Inventors: Seul Ki JEON, Hwaseong-si (KR); Nam Woong HUR, Hwaseong-si (KR); Hyun Sang KIM, Hwaseong-si (KR); Sin Gu KIM, Suwon-si (KR); Cheong Hyun LEE, Seoul (KR); Mi Sun JIN, Seoul (KR); Hye Jin AHN, Seoul (KR)

(21) Appl. No.: 14/952,127

(22) Filed: Nov. 25, 2015

(30) Foreign Application Priority Data
Aug. 13, 2015 (KR) 10-2015-0114684

(51) Int. Cl. H04L 29/06; H04L 29/08

(52) U.S. Cl. CPC H04L 63/0861; H04L 67/12

(57) ABSTRACT

A system for applying a security mode related to biometric information of a driver includes a driver authentication unit configured to determine whether a driver is a registered driver; a passenger boarding determination unit configured to determine whether a passenger occupies the vehicle when the driver is a registered driver; and a biometric information providing mode execution unit configured to provide personal or biometric information to the driver when the passenger boarding determination unit determines that the driver is the only occupant of the vehicle, and to execute a security mode when the driver is not a registered driver or when the driver is not the only occupant of the vehicle.

### CROSS-REFERENCE TO RELATED APPLICATION

This application claims the benefit of priority to Korean Patent Application No. 10-2015-0114684, filed on Aug. 13, 2015 in the Korean Intellectual Property Office, the entirety of which is incorporated herein by reference.

### TECHNICAL FIELD

The present disclosure relates to a system and a method for protecting the security of biometric information of a driver, and more particularly, to a technology for protecting the biometric information of a driver of a vehicle.

### BACKGROUND

Biometrics is an authentication method that extracts a person's unique biometric data such as fingerprints, iris patterns, sweat gland structure, blood vessel patterns, and the like, which are different for each individual, and utilizes the extracted biometric data as information. In contrast to a key or a password, individual characteristics such as facial features, voice, fingerprints, eyeballs, and the like cannot easily be used by others in an attempt to steal or copy an individual's characteristics, and furthermore, there is no risk of changing or losing such biometric data. Accordingly, biometrics may provide an excellent resource in the security field. In particular, it is possible to implement duplicate authorization for a user such that a safe system can be built in terms of back-up security. Various biometrics, for example, fingerprints, voice, facial recognition, iris patterns, the lines of the palm, vein distribution, and the like, may be used.

A finger scan is one of the most popular biometric methods. A fingerprint is formed in the dermis, which is the bottom layer of the epidermis of the skin, and it does not change over a person's lifetime as long as the dermis is not damaged. Hence, it has been generally used for a long time as a method for recognizing a person individually. However, when the fingerprint is worn down due to manual labor or when the finger is dry, or stained with a foreign object, it is difficult to recognize a user.

Vein recognition technology is a technique for recognizing the shape of a blood vessel of the back of the hand or a wrist, and performs an identification using reflection after imaging a blood vessel using infrared light. This technology has high security because it is impossible to reproduce. However, it has not been proven that the shape of the vein is unique to each person, and that it does not change during a person's life. In addition, the hardware configuration is complex and the overall system cost is large. Accordingly, the scope of application is limited.

An iris scan uses the iris pattern of an eyeball, which has unique characteristics for each person. It is regarded as the most advanced security system in comparison to the finger scan or retina recognition in terms of the accuracy of the data, reliability, ease of use, and processing speed. The iris has a unique pattern formed within one or two years of birth and does not change during a person's life, and identification may be performed by converting the folds of the iris into a frequency in the case of the iris recognition. Furthermore, it is almost impossible to copy the iris of a living person because of fine tremor. Iris recognition adopts a non-contact method that recognizes the iris pattern by an auto focus camera with 8-25 cm distance.

Voice recognition uses the fact that information on the pitch of voice according to the intonation and the talking habit of a person has its own characteristic. Voice recognition has several advantages, including that identification can be performed remotely using a phone unlike other biometric devices, no additional training is required, and the system cost is low. On the other hand, it may not recognize a user when the user's voice is hoarse from a cold or another factor, it is possible to mimic another person's voice intentionally, and there may be disruptive loud noises in the surrounding environment. Thus, in order to apply voice recognition to the field of security technology, the technology of extracting a voice signal after noise processing must be a priority.

Facial recognition is divided into a method of identifying the shape of a face in three dimensions and a method of analyzing the thermal distribution of the face. Facial recognition performs well with regard to analyzing the face, but deviation in recognition may be large depending on the angle of face, the presence of a beard, changes in facial expression, and the lighting.

Palm print (the lines of the palm) recognition uses the lines of the palm distributed in the palm of a person, and it is based on the fact that all individuals have unique palm print patterns, but there the accuracy of palm print recognition is poor.

Recently, multimodal biometrics which use two or three recognition methods simultaneously has been developed to remedy their shortcomings and enhance the accuracy. Furthermore, biometrics recognizing gait, body odor, ear shape, and genetic information have also been developed.

User identification methods using such biometric information rely on private personal information, and it is difficult to protect such personal information in the vehicle while allowing the driver to be authenticated. It is also difficult in general to authenticate a driver or provide personal information selectively in the vehicle.

### SUMMARY

The present disclosure has been made in view of the above problems. It provides a system and a method for applying a security mode related to the biometric information of a driver such that the biometric information is protected. The biometric information of a driver is not provided in order to protect the driver's biometric information when a passenger boards a vehicle together with the driver.

In accordance with an aspect of the present inventive concept, a system for applying a security mode related to biometric information of a driver includes: a driver authentication unit configured to determine whether a driver within a vehicle is a registered driver; a passenger boarding determination unit configured to determine whether a passenger boards the vehicle when the driver is a registered driver of the driver authentication unit; and a biometric information providing mode execution unit configured to provide personal information or biometric information to the driver when the passenger boarding determination unit determines that the driver boards the vehicle alone, and to execute a security mode, when the driver is not a registered driver, or when both the passenger and the driver board the vehicle. The driver authentication unit authenticates a driver by using an authentication method by identifying a driver using a Bluetooth-enabled device including a mobile device in which the personal information or the biometric information is previously built, an authentication method by using a finger scan of driver's seat or a door in the vehicle, a method of recognizing iris by using a camera provided in an interior of the vehicle, or an authentication method by assigning a unique number to a smart key. The passenger boarding determination unit determines the boarding of the passenger by providing a piezoelectric sensor to a passenger seat in addition to the driver's seat in the vehicle, or receiving the personal information or the biometric information of the passenger in addition to the driver by using a camera or a radar. The biometric information providing mode execution unit operates a health care system, after providing the personal information or the biometric information to the driver. The biometric information providing mode execution unit executes a security mode when the driver is not a registered driver in a driver authentication procedure of the driver authentication unit so that the personal information or the biometric information of the driver is not provided, or executes the security mode when both the passenger and the driver board the vehicle in a procedure in which the passenger boarding determination unit determines whether the passenger boards the vehicle so that the personal information or the biometric information of the driver is not provided. In accordance with another aspect of the present inventive concept, an operation method of a system for applying a security mode related to biometric information of a driver includes: determining whether a driver within a vehicle is a registered driver; determining whether a passenger boards the vehicle when the driver is a registered driver; providing personal information or biometric information to the driver when it is determined that the driver boards the vehicle alone; and executing a security mode, when the driver is not a registered driver, or when both the passenger and the driver board the vehicle. Determining whether a driver within a vehicle is a registered driver includes authenticating a driver by using an authentication method by identifying a driver using a Bluetooth-enabled device including a mobile device in which the personal information or the biometric information is previously built, an authentication method by using a finger scan of driver's seat or a door in the vehicle, a method of recognizing iris by using a camera provided in an interior of the vehicle, or an authentication method by assigning a unique number to a smart key. Determining whether a passenger boards the vehicle includes determining the boarding of the passenger by providing a piezoelectric sensor to a passenger seat in addition to the driver's seat in the vehicle, or receiving the personal information or the biometric information of the passenger in addition to the driver by using a camera or a radar. Providing personal information or biometric information to the driver includes operating a health care system, after providing the personal information or the biometric information to the driver. Executing a security mode includes executing a security mode when the driver is not a registered driver in a driver authentication procedure of the driver authentication unit so that the personal information or the biometric information of the driver is not provided, or executing the security mode when both the passenger and the driver board the vehicle in a procedure in which the passenger boarding determination unit determines whether the passenger boards the vehicle so that the personal information or the biometric information of the driver is not provided. If both the passenger and the driver board the vehicle, when the driver inputs a signal for the purpose of disabling the security mode, the security mode is disabled to provide the biometric information.

### BRIEF DESCRIPTION OF THE DRAWINGS

The objects, features and advantages of the present inventive concept will be more apparent from the following detailed description in conjunction with the accompanying drawings, in which:

FIG. 1 is a block diagram illustrating a configuration of a system for applying a security mode related to biometric information of a driver according to an embodiment of the present inventive concept;

FIG. 2 is a flowchart illustrating an operation method of a system for applying a security mode related to biometric information of a driver according to an embodiment of the present inventive concept;

FIG. 3 is a flowchart illustrating a procedure of disabling a security mode after executing the security mode related to biometric information of a driver according to an embodiment of the present inventive concept; and

FIG. 4 to FIG. 7 are diagrams illustrating an operation method depending on the boarding or the position of a driver or a passenger in a system for applying a security mode related to biometric information of a driver according to an embodiment of the present inventive concept.

### DETAILED DESCRIPTION OF EXEMPLARY EMBODIMENTS

Exemplary embodiments of the present inventive concept are described with reference to the accompanying drawings in detail. The same reference numbers are used throughout the drawings to refer to the same or like parts. Detailed descriptions of well-known functions and structures incorporated herein may be omitted to avoid obscuring the subject matter of the present inventive concept.

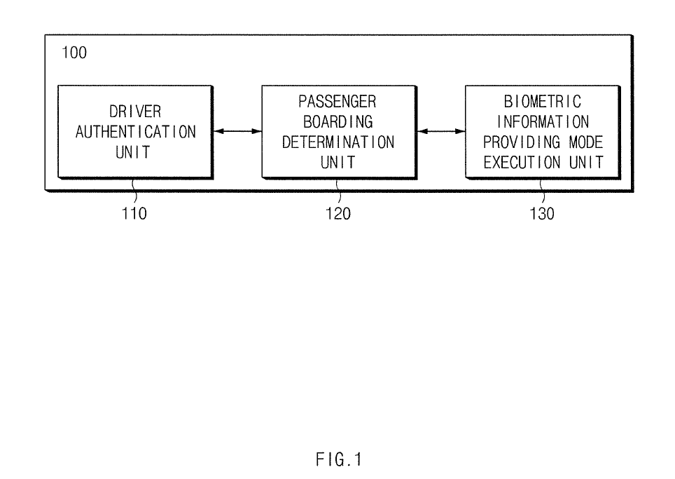

FIG. 1 is a block diagram illustrating a configuration of a system for applying a security mode related to biometric information of a driver according to an embodiment of the present inventive concept.

Referring to FIG. 1, a system 100 for the security of biometric information of a driver may include a driver authentication unit 110, a passenger boarding determination unit 120, and a biometric information providing mode execution unit 130. The driver authentication unit 110 may determine whether the driver within a vehicle is a registered driver.

In detail, a system 100 for the security of biometric information of a driver may be processors or programmable computers etc the driver authentication unit 110 may authenticate the driver by identifying the driver using a Bluetooth-enabled device such as a mobile device in which individual unique information or biometric information is previously built, by using a finger scan of the driver's seat or a door in the vehicle, by using a camera provided in the interior of the vehicle, by assigning a unique number to a smart key, by using an AVN (Audio/Video/Navigation) device, or the like.

The passenger boarding determination unit 120 may determine whether a passenger boards the vehicle when the driver is a registered driver of the driver authentication unit 110.

In detail, the passenger boarding determination unit 120 may determine the boarding of the passenger by providing a piezoelectric sensor in a passenger seat in addition to the driver's seat in the vehicle, or receiving biometric information of the passenger in addition to the driver by using a camera or a radar. When the passenger boarding determination unit 120 determines that the driver boards the vehicle alone, the biometric information providing mode execution unit 130 may provide personal information or biometric information to the driver and a health care system that uses the personal or biometric information of the driver may be operated.

However, the biometric information providing mode execution unit 130 may alternatively execute the security mode when the driver is not a registered driver. Accordingly, a driver authentication procedure of the driver authentication unit 110 may operate so that the personal information or the biometric information of the driver will not be provided.

In addition, the biometric information providing mode execution unit 130 may execute the security mode when the passenger boards the vehicle in addition to the driver. In this procedure, where the passenger boarding determination unit 120 determines that a passenger boarded the vehicle, the personal or biometric information of the driver will not be provided.

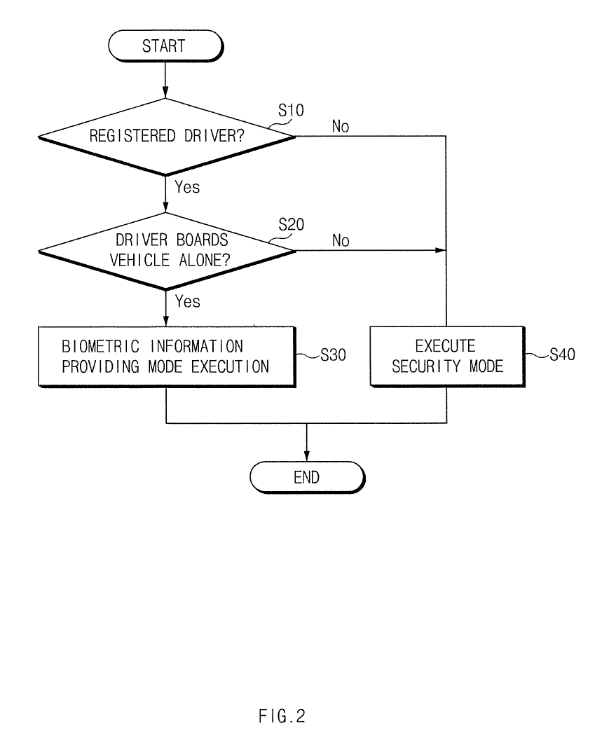

FIG. 2 is a flowchart illustrating an operation method of a system for applying a security mode related to biometric information of a driver according to an embodiment of the present inventive concept.

Referring to FIG. 2, the driver authentication unit in the system for a security of biometric information of a driver may determine whether the driver in the vehicle is a registered driver (S10). The method of determining whether the driver is a registered driver may use various authentication methods, including identifying the driver using a Bluetooth-enabled device such as a mobile device in which individual unique information or biometric information is previously built, using a finger scan of the driver's seat or a door in the vehicle, recognizing a driver's iris using a camera provided in the interior of the vehicle, or assigning a unique number to a smart key, or the like.

Next, when the driver authentication unit determines that the driver is a registered driver, the passenger boarding determination unit 120 in the system for a security of biometric information of a driver may determine whether a passenger boards the vehicle (S20). Here, the method for determining whether the passenger boards the vehicle may determine the boarding of the passenger by providing a piezoelectric sensor in a passenger seat in addition to the driver's seat in the vehicle, or by receiving biometric information of the passenger in addition to the driver using a camera or a radar.

However, when the driver is not a registered driver in a driver authentication procedure of the driver authentication unit, the biometric information providing mode execution unit may execute a security mode so that the personal information or the biometric information of the driver may not be provided.

Next, when the passenger boarding determination unit in the system for a security of biometric information of a driver determines that the driver boards the vehicle alone, the biometric information providing mode execution unit may provide personal information or biometric information to the driver. In addition, a health care system that uses the personal or biometric information of the driver may be operated (S30).

However, when the biometric information providing mode execution unit executes the security mode when the passenger boards the vehicle in addition to the driver in a procedure in which the passenger boarding determination unit determines that a passenger boarded the vehicle, the personal or biometric information of the driver will not be provided (S40).

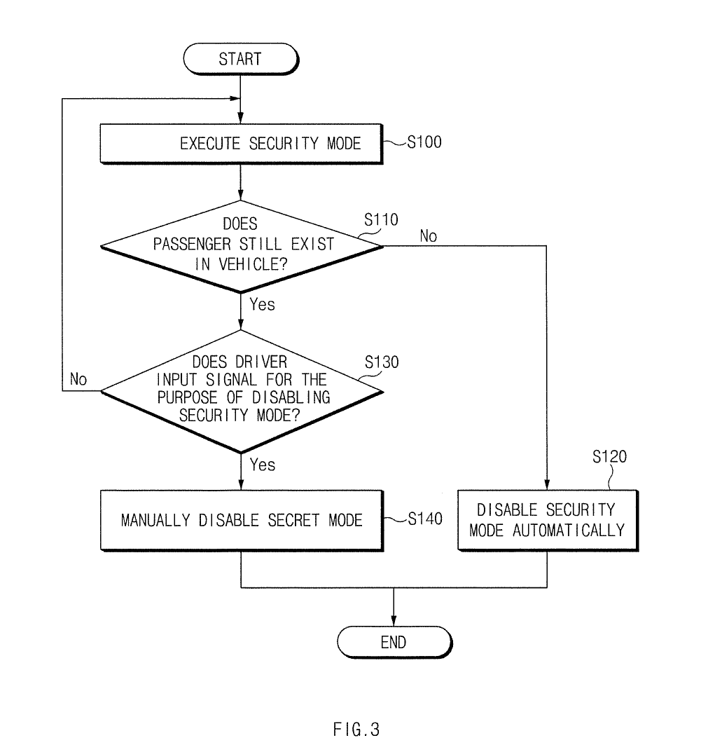

FIG. 3 is a flowchart illustrating a procedure of disabling a security mode after executing the security mode related to biometric information of a driver according to an embodiment of the present inventive concept.

Referring to FIG. 3, when the biometric information providing mode execution unit executes the security mode in FIG. 2, the passenger boarding determination unit in the system for a security of biometric information of a driver determines again whether the passenger is still present in the vehicle (S100, S110).

Here, the passenger boarding determination unit determines whether passengers are still present in the vehicle. If all passengers exit the vehicle, the biometric information providing mode execution unit may disable the security mode automatically (S120).

However, if the passenger boarding determination unit determines that a passenger is still present in the vehicle, the driver authentication unit determines whether the driver performs an authentication request to the driver authentication unit for the purpose of disabling the security mode (S130).

Next, when the driver authentication unit receives the authentication request for disabling the security mode from the driver, the driver may manually disable the security mode (S140).

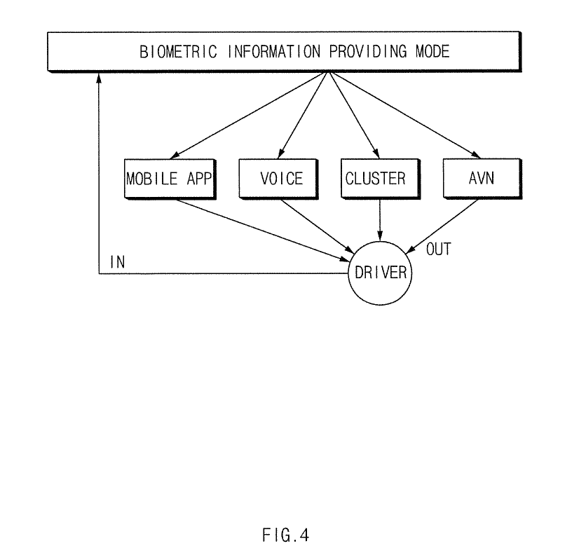

FIG. 4 to FIG. 7 are diagrams illustrating an operation method depending on the boarding or the position of a driver or a passenger in a system for applying a security mode related to biometric information of a driver according to an embodiment of the present inventive concept.

Referring to FIG. 4, when a registered driver boards the vehicle alone, the system may execute a biometric information providing mode for the registered driver via the driver authentication unit and the passenger boarding determination unit. The biometric information providing mode may be provided to the driver through a mobile app, an audio device, a cluster, a Head Up Display (HUD), or an AVN device.

Here, when the biometric information providing mode is executed as the registered driver boards the vehicle alone, the driver may receive the personal or biometric information of the registered driver through all devices or applications including the mobile app, the audio device, the cluster, the Head Up Display (HUD), or the AVN device.

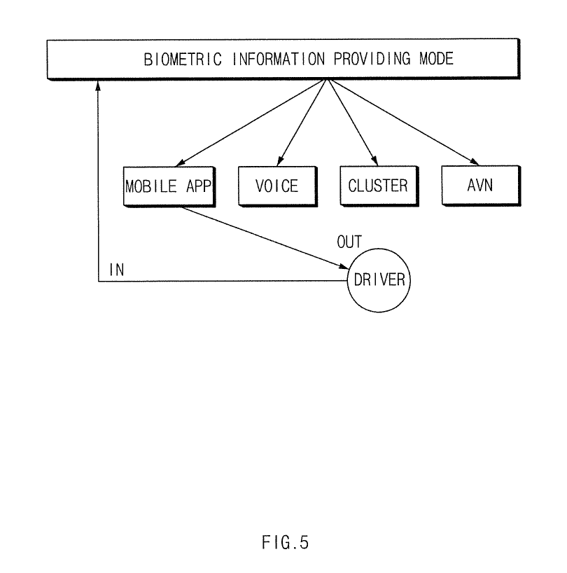

Referring to FIG. 5, when the registered driver and the passenger sit in the driver seat and the passenger seat side by side, the system may execute a security mode for protecting the personal or biometric information of the driver via the driver authentication unit and the passenger boarding determination unit. The security mode may be provided to the driver through the mobile app, the audio device, the cluster, the Head Up Display (HUD), or the AVN device.

Here, when the registered driver and the passenger sit in the driver seat and the passenger seat side by side, the driver may receive the personal information or the biometric information of the driver only through the mobile app.

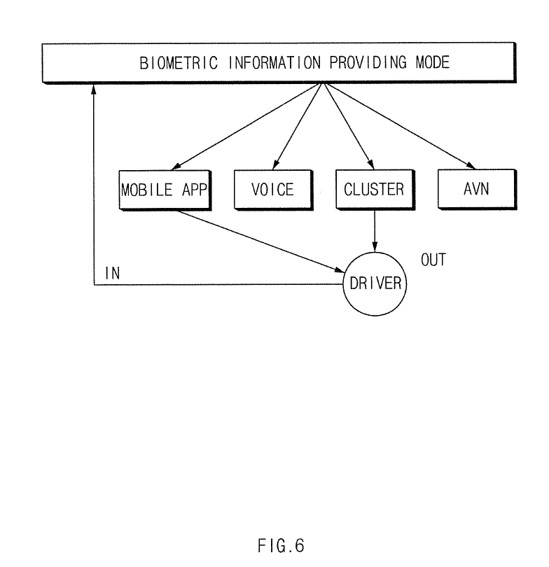

Referring to FIG. 6, when the registered driver and the passenger sit in the back seats side by side, the system may execute a security mode for protecting the personal information or the biometric information of the driver via the driver authentication unit and the passenger boarding determination unit. The security mode may be provided to the driver through the mobile app, the audio device, the cluster, the Head Up Display (HUD), or the AVN device.

Here, when the registered driver and the passenger sit in the back seats side by side, the driver may receive the personal or biometric information of the driver only through the mobile app or the cluster.

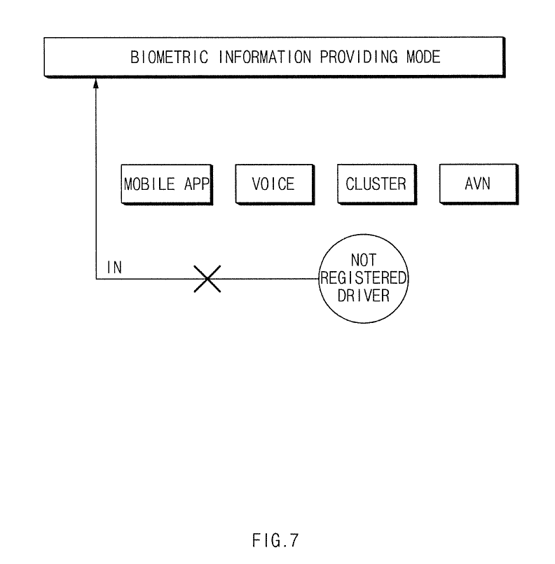

Referring to FIG. 7, when a driver who is not registered in the vehicle boards the vehicle, the system may execute a security mode for protecting the personal or biometric information of the registered driver via the driver authentication unit. The security mode may be provided to the driver through the mobile app, the audio device, the cluster, the Head Up Display (HUD), or the AVN device.

Here, when a driver who is not registered in the vehicle boards the vehicle, the driver will not be able to receive the personal or biometric information of the registered driver.

As described above, the present technology does not provide the biometric information of the driver when a passenger boards a vehicle.

In addition, in the present technology, when a passenger boards the vehicle, the system automatically recognizes the passenger, and provides the security service so that a separate operation of a driver is not required.

Although exemplary embodiments of the present inventive concept have been described in detail hereinabove, it should be clearly understood that many variations and modifications of the basic inventive concepts herein taught which may appear to those skilled in the present art will still fall within the spirit and scope of the present inventive concept, as defined in the appended claims.

What is claimed is:

1. A system for applying a security mode related to biometric information of a driver, the system comprising:
a driver authentication unit configured to determine whether a driver is a registered driver;
a passenger boarding determination unit configured to determine whether a passenger occupies the vehicle when the driver is a registered driver; and
a biometric information providing mode execution unit configured to provide personal or biometric information to the driver when the passenger boarding determination unit determines that the driver is the only occupant of the vehicle, and to execute a security mode when the driver is not a registered driver or when the driver is not the only occupant of the vehicle.

2. The system of claim 1, wherein the driver authentication unit authenticates the driver using an authentication method selected from the group consisting of: identifying a driver using a Bluetooth-enabled device including the personal or biometric information, using a finger scan of the driver disposed in a driver's seat or a door of the vehicle, recognizing an iris of the driver using a camera provided in an interior of the vehicle, and assigning a unique number to a smart key.

3. The system of claim 1, wherein the passenger boarding determination unit determines whether the passenger occupies the vehicle using a piezoelectric sensor in a passenger seat or by receiving personal or biometric information of the passenger using a camera or a radar.

4. The system of claim 1, wherein the biometric information providing mode execution unit communicates with a health care system after providing the personal or biometric information to the driver.

5. The system of claim 1, wherein the biometric information providing mode execution unit executes a security mode when the driver is not a registered driver in a driver authentication procedure of the driver authentication unit so that the personal or biometric information of the driver is not provided, or executes the security mode when both the passenger and the driver occupy the vehicle in a procedure where the passenger boarding determination unit determines the passenger occupies the vehicle so that the personal or biometric information of the driver is not provided.

6. An operation method of a system for applying a security mode related to biometric information of a driver, the operation method comprising steps of:
determining whether a driver is a registered driver;
determining whether a passenger occupies the vehicle when the driver is a registered driver;
providing personal or biometric information to the driver when it is determined that the driver is the only occupant of the vehicle; and
executing a security mode when the driver is not a registered driver or when both the passenger and the driver occupy the vehicle.

7. The operation method of claim 6, wherein the step of determining whether a driver within a vehicle is a registered driver comprises authenticating a driver by using an authentication method selected from the group consisting of: identifying the driver using a Bluetooth-enabled device including the personal or biometric information, using a finger scan of the driver disposed in a driver's seat or a door of the vehicle, recognizing an iris of the driver using a camera provided in an interior of the vehicle, or assigning a unique number to a smart key.

8. The operation method of claim 6, wherein the step of determining whether a passenger occupies the vehicle comprises providing a piezoelectric sensor in a passenger seat in the vehicle or receiving the personal or biometric information of the passenger by using a camera or a radar.

9. The operation method of claim 6, wherein the step of providing personal or biometric information to the driver comprises communicating with a health care system after providing the personal or biometric information to the driver.

10. The operation method of claim 6, wherein the step of executing the security mode comprises executing the security mode when the driver is not a registered driver in a driver authentication procedure of the driver authentication unit so that the personal or biometric information of the driver is not provided, or executing the security mode when both the passenger and the driver occupy the vehicle when the passenger boarding determination unit determines the passenger occupies the vehicle so that the personal or biometric information of the driver is not provided.

11. The operation method of claim 6, wherein, when both the passenger and the driver occupy the vehicle, the security mode is disabled when the driver inputs a signal for the purpose of disabling the security mode.
